(19) United States
(12) Patent Application Publication
(10) Pub. No.: US 2005/0141699 A1
(43) Pub. Date: Jun. 30, 2005

(54) Modifications to telephones in combination of aesthetic and extra-functional values

(76) Inventor: Aeileen Cheung, Marietta, GA (US)

Correspondence Address: Aeileen Cheung, Owner of GoBusi L.L.C.;Suite 240-439, 3605 Sandy Plains Road, Marietta, GA, 30066, US

(21) Appl. No.: 10/892,717

(22) Filed: Jul. 16, 2004

Related U.S. Application Data
(60) Provisional application No. 60/531,903, filed on Dec. 22, 2003.

(51) Int. Cl. H04M 1/00; H04M 9/00

(52) U.S. Cl. 379/419

(57) ABSTRACT

Novelty-designed telephones incorporate compartments as well as holders for storing & holding mainly office & writing implements, and embody utility facilities for performing simple tasks. Those designs simulate different kinds of, including but not limited to, animals, devices, furniture, houses or any combination of the aforesaid with vivid colors and shapes. The incorporation of compartments is unique in a way that it is built-in and well-covered while that of holders is either position-adjustable or/and having flexible, plastic rings so that whatever position the telephone set is placed, the contents will stay. Moreover, the built-in, covered compartments contain subdivisions to organize and secure different types of stationery. The utility facilities are mostly embedded in a way unifying with the designs. For example, when the telephone set is designed in the shape of an animal, a stapler will usually be embedded in its mouth part so that it will appear as in the biting actions when it is in use.

### FIELD OF THE INVENTION

The present invention relates to modifications to telephones in combination of aesthetic and extra-functional values including both novelty designs and utility facilities.

### BACKGROUND OF THE INVENTION

There were mainly 8 previous patented inventions related to the present invention: U.S. Pat. No. D.285,438 issued in 09/1986 to Chen; U.S. Pat. No. D.291,568 issued in 08/1987 to Basch; U.S. Pat. No. D.291,569 issued in 08/1987 to Sun; U.S. Pat. No. D.301,231 issued in 05/1989 to Yoshiharu; U.S. Pat. No. D.347,006 issued in 05/1994 to Booker; U.S. Pat. No. D.374,229 issued in 10/1996 to Eitzgerald et al.; U.S. Pat. No. 4,368,359 issued in 01/1983 to Genaro et al.; and PCT/AU97/00623 with int. pub. No. WO 98/12855 to Morgante. However, those inventions fail to suggest the possibility of combination of aesthetic and extra-functional values to be included in a telephone as the present invention.

In the use of a telephone, it is often necessary to jot down messages relating to telephone calls. Hence, it is desirable to have at least a note pad or piece of paper and a writing implement proximate to the telephone. A wall telephone, however, may be remote from such stationery. Although former patented invention, a wall telephone stand, by Genaro et al does include such facilities, its bulky and little aesthetic-designed appearance detracts from the appeal to its use as well as of a room.

Besides, the confinement to being only a wall telephone stand of Genaro et al's invention distinguishes its limitation from the flexibility of the present invention, capable of being put on a horizontal surface (e.g. desk, table, night stand, etc.) or hung on a vertical one (e.g. wall, door, etc.). By the same token, the former patented invention, a telephone accessory having a foot portion adapted to be seated and inclined backward on a support surface, by Morgante reveals its limitation to being capable of being put on a horizontal surface only, and again, distinguishes from the flexibility of the present invention, capable of being positioned on either a horizontal or a vertical surface because of having a position-adjustable accessory portion, or/and at least a well-covered stationery-storing compartment preventing the contents from being fallen out when the telephone set is placed or handled in different positions. More detailed comparisons between the former patented invention by Genaro et al and the present one will be discussed in the following paragraphs.

Although the former patented invention, a wall telephone stand, by Genaro et al contains a shallow well on the upper surface of the stand for holding eraser & chalk or pencils & note pad, and a large, open compartment especially designed for storing a directory, there are at least 2 major obvious differences that distinguishes its invention from the present invention.

First, the position of the well on the upper surface of the stand of the former invention is neither adjustable nor movable, which means it is limited to be placed on a vertical surface because the contents on the well will fall off if the stand starts to incline to a horizontal position. The present invention, however, contains position-adjustable round knobs at the base of holders for writing instruments and other stationery, or/and contains flexible, plastic rings to secure them in place so that whatever positions the telephone set is placed, the contents will stay. Whether using position-adjustable round knobs or/and well-designed, plastic rings to achieve the aforesaid purposes will depend on which aesthetic shape (e.g. which kind of animals, devices, furniture, houses, etc.) is chosen for the design on the telephone set.

Second, since both the well and the tall, side compartments of the stand are open to access without any cover, such invention, on the one hand, means easy access for the holding or storing contents, but on the other hand, also means easy slipping and dropping of the contents. Besides, the tall, open compartment is actually not very practical to be used for storing stationery as it claimed except for storing directory because (i) stored contents of stationery (e.g. paper clips, rubber bands, staples, etc.) are most likely to occupy only the lowest surface area of the compartment because of the gravitational force. It is very difficult for such small objects to stack up high & stable to make use of the upper space in such a tall, open compartment. This means actually most of the space in such compartment will be wasted if it is used for storing stationery; (ii) even if it can store a few kinds of them, they will appear disorganized and easily be tangled with one another since they are put in the same, single compartment; (iii) as stated in the above, the stationery will easily slide out drop.

The present invention, however, can offset those shortcomings by installing a well-covered compartment with which a few subdivisions organize and secure different types of stationery.

Some other significant aspects relating to the present invention have to be addressed, too. In addition to the aforesaid benefits of the modifications, a few other extra-functional features that never happened to be included in the telephone set are also invented. Examples include, but are not limited to, stapler, pencil sharpener, tape dispenser, scissors, picture holder(s) or/and business card holder. Please note that not all aforesaid extra-functional features will happen to be included in each aesthetic-designed telephone set. Which feature(s) to be included will depend on which aesthetic shape is chosen for the design on the telephone set.

One may argue that what's the worth of having those extra-functional features included in a telephone set provided that it is put on a horizontal surface where stationery as well as its containers and other office implements (e.g. stapler, pencil sharpener, etc.) as stated in the above can also be put on the same surface? If the present invention is to be placed on a vertical surface, the numerous aforesaid benefits are obvious beyond doubt. If it is to be placed on a horizontal surface, there are still various benefits that cannot be neglected.

Imagine, if the stationery as well as its containers and other office implements have to be put on the same horizontal surface as with a telephone, a pretty large surface area will have to be occupied. It will be difficult, if not impossible, to contain other decorative items (e.g. vase, picture holder, etc.) on the same limited surface (e.g. a night stand or a small desk) to beautify the area and add appeal or match the decor of the room. Under certain circumstances, things like lamp, books or/and other office equipments (e.g. desktop/laptop, printer, disks, scissors, etc.) may also be required to be put on the same surface. Even provided that they could all be put on together, those scattered objects would somehow look disorganized, and they would definitely detract the appeal of a room, even there existed some decorative items.

So, if the present invention provides storing features for stationery and has extra-functional capabilities for serving as (daily/office) implements, (I) it can save quite some space for other purposes. (II) Sometimes, saving space also means saving clutter and becoming more organized. (III) As the present invention combines both aesthetic (designs in the shape of animals, devices, utensils, figurines, furniture, houses, etc.) and extra-functional values, money can also be saved on purchases of some decorative items and office implements since it itself is already an art which achieves both decorative and extra-functional purposes.

### SUMMARY OF THE INVENTION

The present invention enhances both aesthetic and functional values of a telephone by making use of the novelty designs to incorporate holders & compartments for holding & storing mainly writing & office implements (e.g. pen, pencil, eraser, ruler, paper, note pad, correction pen, rubber bands, staples, etc.), and to embody utility facilities for performing simple tasks (e.g. a stapler in the handset, an pencil sharpener in the base, etc.). Those designs simulate, including but not limited to, different types of animals, devices, utensils, figurines, furniture and houses with vivid colors and shapes. The incorporation of the holders & compartments is different from that of the former related patterned inventions in the way that it is position-adjustable or/and well-covered. This means that the present invention has a flexibility of being placed on various surface positions, and again, distinguishes if form the former related patterned inventions.

Please note that the outline of the base may also be changed in accordance with the appearance of the handset.

Whether the base will or will not be modified into a different color and shape depends on what kind of animal, device, figuring, furniture, etc to be resembled. Please see FIG. 1, 7 & 13 for references. Please also note that the texture of the exterior may also be, but not necessarily, changed, too.

For example, the handset and the base of the telephone can simulate a cow on a meadow where colorful, decorative, synthetic fur is used to cover them, thereby providing a soft texture when the user engages the telephone. Please see FIG. 9 for reference. It is desirable, but not necessary, for the ring tones to simulate the sound of the type of animal, device or figurine the telephone mimics. So if the telephone simulates a cow, a mooing tone will sound when a phone call is received.

### BRIEF DESCRIPTION OF THE DRAWINGS

The invention is herein illustrated, by means of a few embodiments of aesthetic designs, with reference to the accompanying drawings, wherein:

FIG. 1 illustrates a front view of one aesthetic embodiment of a telephone set (designed in the shape of a sleeping bear on a bed) according to the present invention, including 3 position-adjustable picture and stationery holders, a well-covered compartment with subdivisions, a stapler and a pencil-sharpener embedded in the design according to the present invention;

FIG. 2 illustrates the side view of FIG. 1, indicating one of the possible placements of the telephone set (i.e. being put on a horizontal surface);

FIG. 3 illustrates the side view of FIG. 1, indicating another possible placement of the telephone set (i.e. being put on a vertical surface);

FIG. 4 illustrates the back view of the receiver only (as the sleeping bear in FIG. 1), showing the back view of the stapler being united as part of it, the sound receiving as well as transmitting hole parts, a recessed part to be hung on with the base to keep in position when the telephone is not in use, especially when the whole set is placed on a vertical surface, and keypads designed in, including but not exclusively, lip shapes (i.e. they can be in other shapes like heart, star, ball, house, animal, device, utensil, figurine, furniture, automobile, etc.);

FIG. 5 illustrates the front view of the base only (as the bed in FIG. 1), showing the exposed, inside view of the compartment when its cover is slid open, and a hook to hang fast with the recessed part of the receiver;

FIG. 6 illustrates a simplified variation of FIG. 1, which is without the embedded stapler and pencil-sharpener, for the purpose of providing options for manufacturers and end-users;

FIG. 7 illustrates a side view of another aesthetic embodiment of a telephone set (designed in the shape of an iron) according to the present invention, including 2 well-covered compartments (with subdivisions) on both sides, a note-pad or small pieces of paper holder at the end, 2 or 4 pen & pencil holders and a pencil-sharpener with its container incorporated with the design according to the present invention;

FIG. 8 illustrates the bottom view of the scrap container (from the pencil-sharpener) of FIG. 7, showing where and how the trash inside the container to be released and dumped;

FIG. 9 illustrates a side view of another aesthetic embodiment of a telephone set (designed in the shape of a cow on a meadow) preferable with the use of synthetic fur as its exterior cover according to the present invention, including 2 specifically-designed horns used as pen or pencil holders, a well-covered compartment (with subdivisions) a stapler & a pencil-sharpener blended in with the design, and a snail-shaped tape dispenser under the stomach of the cow on the meadow according to the present invention.

FIG. 10 illustrates the front view of the compartment only (as the stomach part of the cow in FIG. 9), showing its exposed inside view when the cover is pulled open (by the lip lid);

FIG. 11 illustrates the front view of the pencil sharpener only (as the front-leg part of the cow in FIG. 9), showing how the container can be removed for scrap disposal;

FIG. 12 illustrates a side view of an alternative variation to FIG. 9, indicating one of the possible expansions of the holding and storing capacities of FIG. 9 for the purpose of providing options of manufacturers and end-users.

FIG. 13 illustrates a front view of another aesthetic embodiment of a telephone set (designed in the shape of a house) according to the present invention, including 2 well-covered compartments with subdivisions, 1 drawer-lie compartment with a step-like recessed handle, 4 small picture holders with a tag under each of them, 1 large picture holder with subdivisions, and a pencil-sharpener embedded in the design according to the present invention;

FIG. 14 illustrates the front view of an alternative variation to FIG. 13, indicating one of the possible modifications of the use of one of the picture holders—that is, changing it into a business card holder. FIG. 14 also illustrates an addition of a dog-shaped tape dispenser which can also be present in FIG. 13.

FIG. 15 illustrates the front view of an alternative variation to FIG. 1—Telephone set designed in the shape of a sleeping bear on a bed, indicating one of the possible changes on the design of the picture holder, which is in front of the rectangular (stationery) holder. All features in FIG. 15 remain the same as those in FIG. 1; the only difference is on the design of the picture holder.

FIG. 16 illustrates the front view of a possible variation to FIG. 15, showing a built-in slit picture holder with stain-glass effect décor. The main difference between the two figures is on the inserting part of the picture (or the like) as well as the supporting part associated with it.

FIG. 17 illustrates the front view of another possible variation to FIG. 1 as on the design of the picture holder, indicating a rectangular frame (with pads or supporting materials underneath which are shown as U-shaped dotted lines in the figure) and, including but not limited to, bear-foot prints as decorative design on it.

While the invention has been described with respect to a limited number of embodiments, it will be appreciated that many variations, modifications and other applications of the invention may be made.

### DETAILED DESCRIPTIONS OF THE DRAWINGS

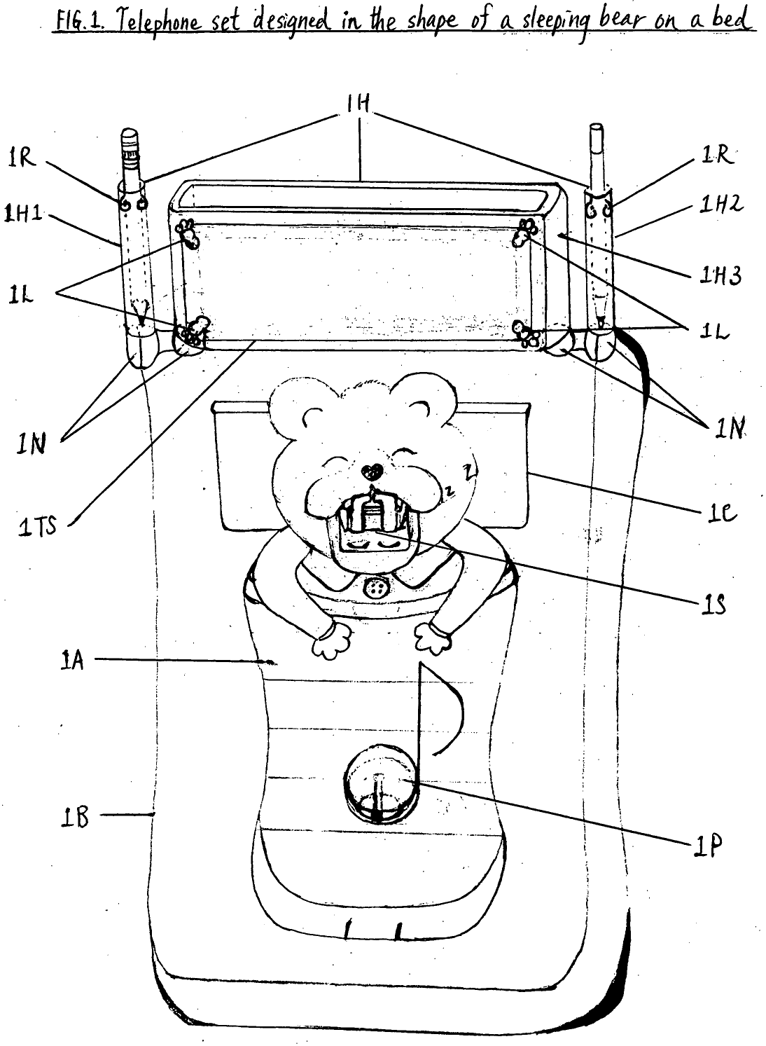

Referring to FIG. 1, a telephone set in accordance with the present invention is designed in the shape of a sleeping bear on a bed. The receiver 1A is made in the shape of a sleeping bear with an embedded stapler 1S and pencil sharpener 1P while the base 1B is made in the shape of a bed with 3 position-adjustable stationery and picture holders resembling a headboard 1H of the bed and a compartment 1C resembling a pillow according to the present invention. The base of the 3 holders, made of spherical plastic knobs 1N, are flexible to be moved at different angles to the base so that whatever surfaces the telephone set is placed, the contents inside them will not fall out.

The two cylindrical holders (1H1 & 1H2) are designed to hold writing implements (e.g. pen, pencil, marker, etc.) while the rectangular holder 1H3 is designed to hold, including but not limited to, stationery and office implements (e.g. paper, note pad, ruler, eraser, correction pen, book mark, etc.). Inside 1H1 & 1H2, there are flexible, plastic rings 1R (near the opening) to help secure short implements in place so that they will not fall down to the bottom and become difficult to be taken out for use. The front of 1H3 has 4 decorative latches 1L, including but not exclusively, in bear-foot patterns to hold a, preferably but not exclusively, 6×4 inches picture or the like. 1L can be made of any shape, color, material, or covered by a transparent slide 1TS to protect the picture.

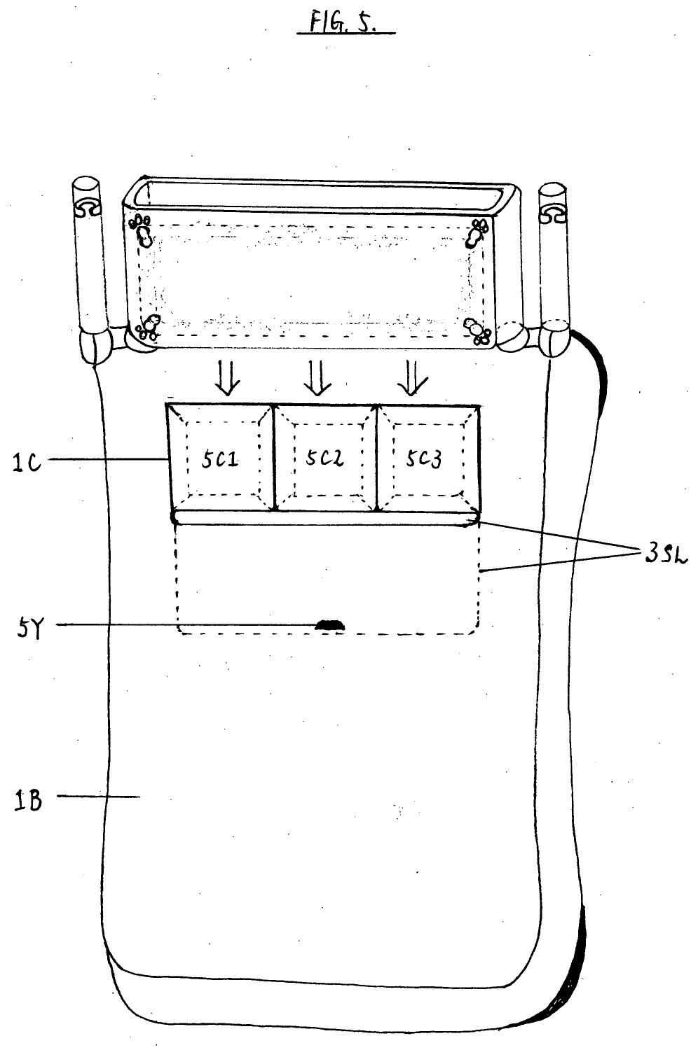

The well-covered compartment 1C, which is in 1B under the top of 1A, gives users more space for storing, including but not limited to, stationery and office implements (e.g. paper clips, staples, erasers, etc.). Moreover, it gives users more organized facilities because it contains a few subdivisions within 1C (3 sub-compartments in this case) for them to tidy up and secure with different types of aforesaid implements. More details about 1C will be discussed later on as the exposed view of the base 1B as well as 1C is shown in FIG. 5.

The bear-shaped receiver 1A has mainly 2-embedded utility facilities for performing simple tasks according to the present invention, namely, a stapler 1S and a pencil sharpener 1P. 1S is embedded in the mouth part of the sleeping bear while 1P is embedded in the blanket part of it.

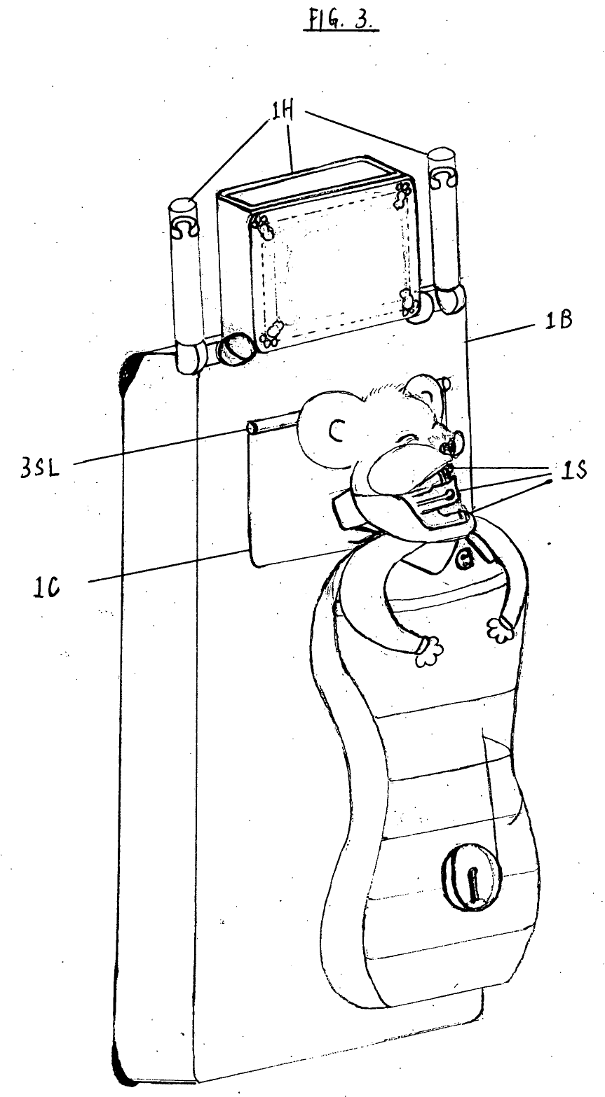

1S is embedded in a way that the upper pressing blade lever (to the staples) is attached to the upper jaw of the bear while the lower pressed indent lever including the part for placing staples is attached to the lower jaw of it. The 2 jaws are made separately from each other for convenient and flexible operation of 1S. The 2 levers are joined at the rear end as common constitution of a stapler. Because of the incorporation, the top (head) part of 1A is not on a surface plane as the rest part of the receiver (except the part of insertion of 1P). Please see FIGS. 3 & 4 for more detailed illustrations of this part.

1P, appearing as a musical note in this case, is actually embedded halfway into the lower (blanket) part of 1A for easy grab for use and removal by means of screwing or pushing-in & out interactions.

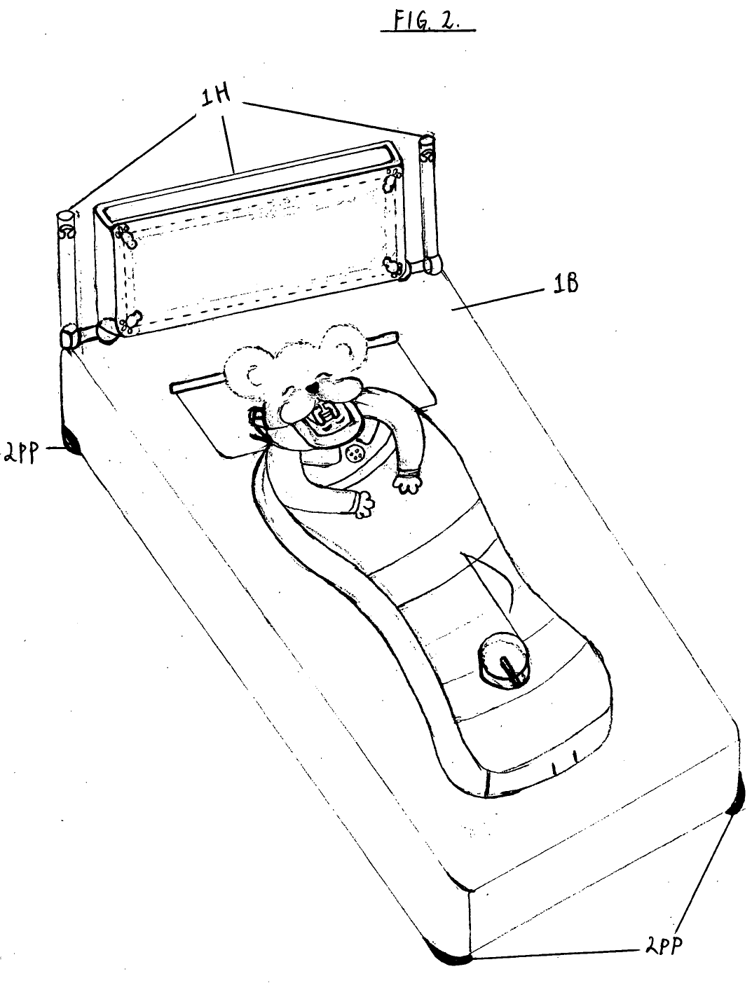

FIG. 2 illustrates the perspective side view of the telephone set when it is placed on a horizontal surface. 1H is adjusted to around 90° to the base 1B so that the contents inside 1H remain securely held. There are 4 plastic pads 2PP at the base corners of 1B resembling legs of a bed to prevent the telephone set from slipping from a surface.

FIG. 3 illustrates the perspective side view of the telephone set when it is placed on a vertical surface. 1H is adjusted to 180° to 1B (i.e. 1H is in an upright position as 1B) so that the contents inside 1H remain securely held. Moreover, the contents inside 1C are also securely held owing to having a well-covered sliding lid 3SL. The embedded stapler 1S in the mouth part extends through the back to which the 3 levers (including the one holding staples) join at the end. The upper and lower jaw parts of the bear are separate from each other (indicated by a line from the mouth corner) but attached to the upper and lower levers of 1S respectively so that the levers are flexible to move for stapling operation.

The jaw parts are not falling apart, though separate, from each other because of the attachments to the levers which join at the end (i.e. at the back of the bear's head).

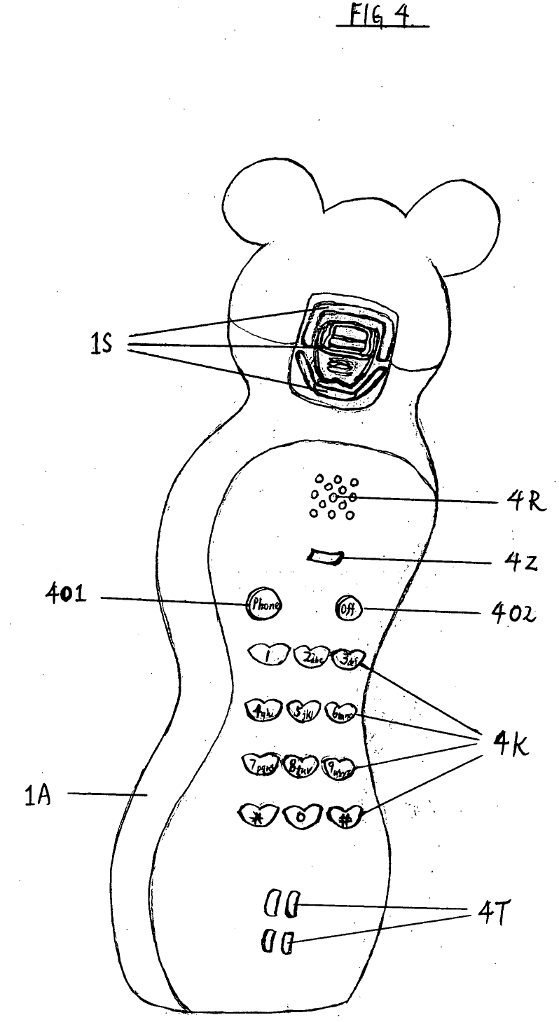

FIG. 4 illustrates the perspective view of the other side (back view) of 1A when it is picked up to be used. Sound receiving hole part 4R is under the (top) bear's head part (i.e. under 1S) so that 4R and 1S do not interfere with each other. There is a recessed part 4Z under 4R made to be hung with the base 1B to keep in position when the phone is not in use. There are “On/Phone” and “Off” buttons 401 and 402 under 4R for cordless receiver for the convenience of making, receiving and terminating a phone call even when it is not placed with 1B. The keypads 4K are in, including but not exclusively, lip shapes. 4K can be in other novelty shapes such as heart, star, animal, etc or in traditional ones such as circle or rectangle. It is preferable, but not necessary, for 4K to be accompanied with light when 1A is picked up to be used. Sound transmitting hole part 4T is under 4K. The bear's body part (i.e. from 4R to 4T) is made in smooth curve shape for easy grab and comfortable counterpart with the contour of a user's face when it is picked up to be used.

FIG. 5 illustrates the exposed, inside view of 1C when the cover 3SL is slid open. The dotted line indicates 3SL, having been slid open, is under the exterior of 1B. There are 3 subdivisions, namely, 5C1, 5C2 and 5C3 under the slide cover in this case, and each of them is equal in size to one another. The number and size of subdivisions, however, can be varied, depending on the actual availability of space which does not interfere with the electronic and electrical parts of the telephone set. They help store and organize different types of, including but not limited to, stationery and office implements (e.g. paper clips, rubber bands, staples, erasers, etc.). There is a hook 5Y under 1C used to hang with the recessed part 4Z when 1A is not in use. In other cases, the well-covered compartment can be in any shape (besides pillow), in any part of the phone set, and opened in any way (other than slid e.g. pulled or pushed open).

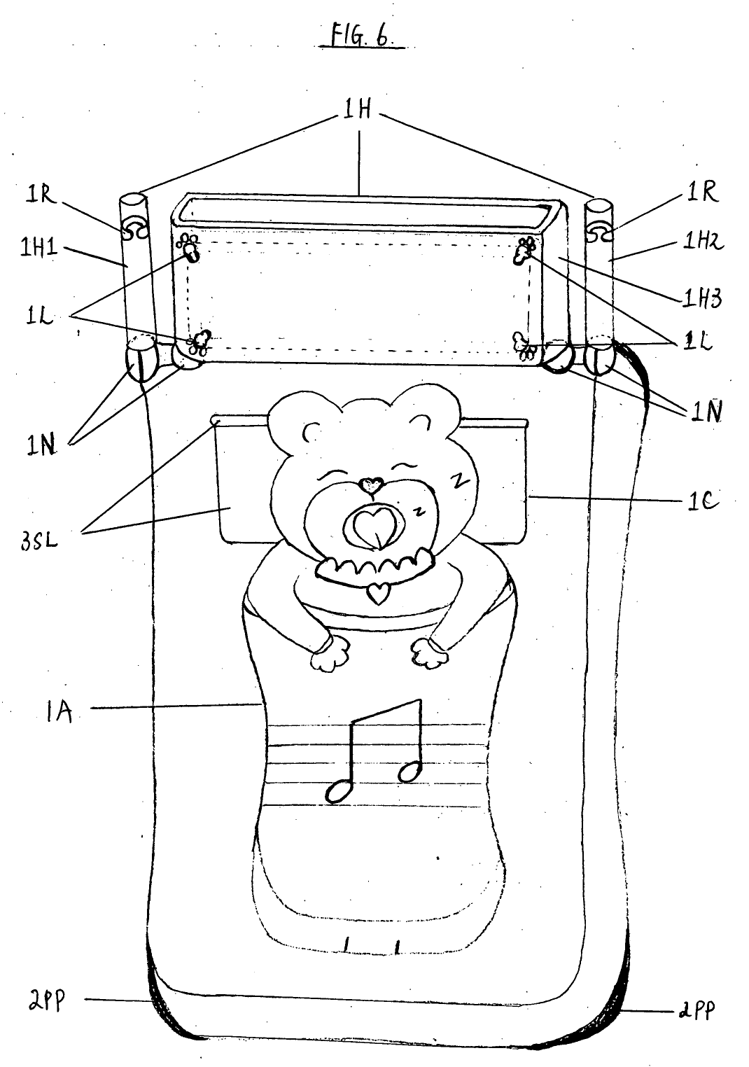

FIG. 6 illustrates a simplified variation to FIG. 1, which is without the embedded stapler 1S and pencil-sharpener 1P, for the purpose of providing options for manufacturers and end-users. The whole front receiver 1A will become a plane surface with curvature when without 1S and 1P.

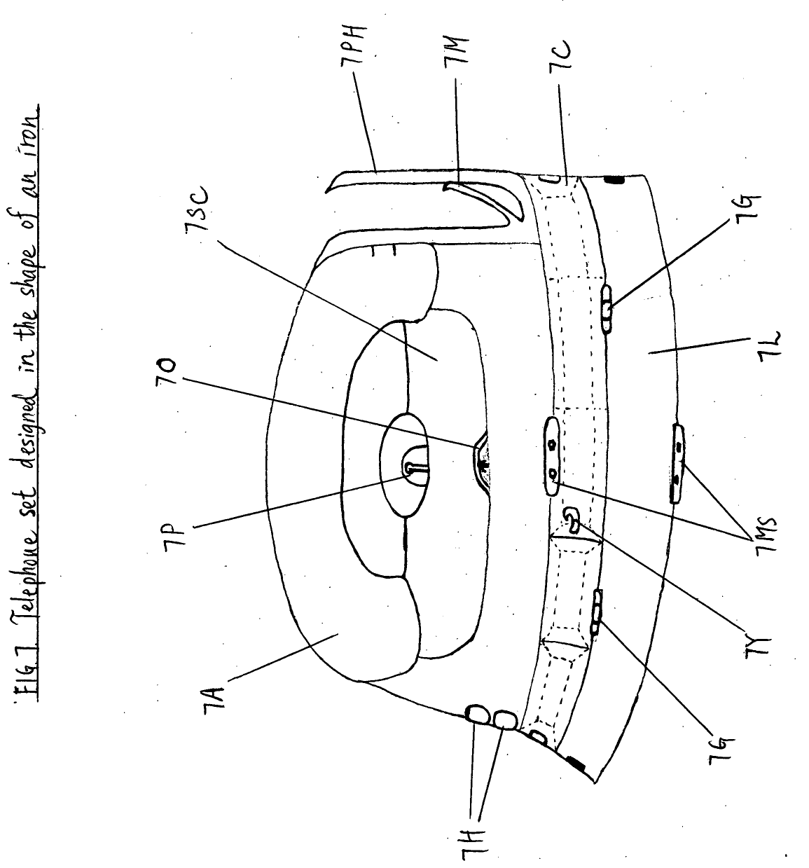

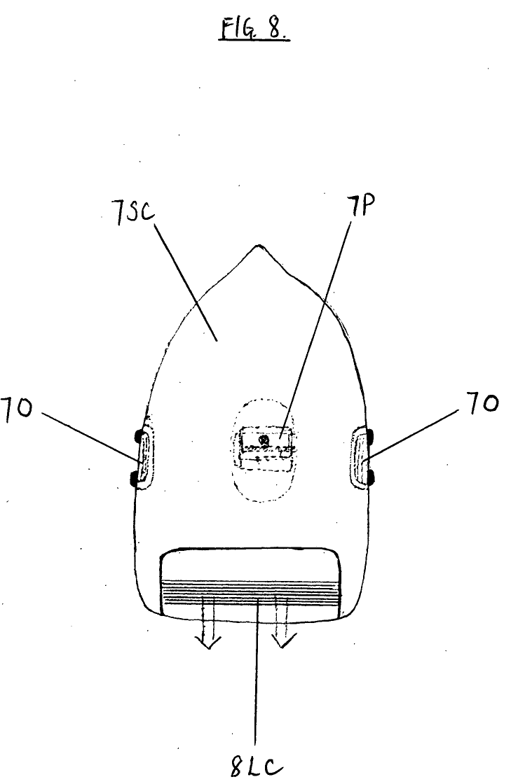

FIG. 7 illustrates a perspective side view of another aesthetic embodiment of a telephone set designed in the shape of an iron according to the present invention. The receiver 7A is placed on the top, resembling the handle of an iron. Under 7A, there is a pencil sharpener 7P with its scrap container 7SC resembling the button-controlling and the water-containing parts of an iron respectively. There are 2 pulled-up elastic openers 7O on the sides of 7SC to remove it from the telephone set for scrap disposal. How the scrap can be removed from 7SC will be explained in detail in FIG. 8.

AT the one end under 7SC (on the left hand side of FIG. 7), there are 4 cylindrical holders 7H (on both sides, but can also be just one on each side depending on the availability of space), resembling the water-filling holes of an iron, designed to hold writing implements (e.g. pen, pencil, market, etc.). Inside 7H, there is a flexible, plastic ring 7R (near the opening of each holder as 1R) to prevent the writing implements from sliding out when the telephone set is placed on a horizontal surface as shown in FIG. 7. In addition to fastening the writing implements, 7R has other 2 major advantages as follows:

First, 7H only need to be made around 3 inches deep in order to hold and prevent the writing implements from falling off due to the presence of 7R. Less than 3-inch depth is possible to achieve the aforesaid purposes (with the use of 7R), however for the aesthetic point of view, it is not recommended because too shallow 7H become, too protruding the writing implements will be to the outside space.

Second, when 7H are used for holding short writing implements, for example, almost used-up 2-inch pencils, 7R will help secure them in place so that they will not slide deep down to the bottom of the holder and become difficult to be taken out for use.

At the other end opposite to 7H, there is an open holder 7PH to contain, including but not limited to, note pads or pieces of paper. 7PH is open so that it can hold different sizes of note pads or paper. There is a metal clip 7M in the middle of 7PH used to hold them in place so that they will not fall out when the telephone set is placed at different positions.

At the bottom layer of the base, there are 2 well-covered compartments 7C (with subdivisions) on both sides. The lid covers 7L of 7C are kept closed by 2 magnetic stripes 7MS which can also be pulled open, with hinges 7G at the base of the lids to facilitate their movement. Each 7C has at least 3 subdivisions or 5 at most. If 3 subdivisions are chosen to be made, they can be created into equal sizes, or preferably as shown in FIG. 7, two of them can be made in equal sizes while the third one is around 3 times larger than each of them so that larger implements (e.g. correction pen, ruler, cutter, scissors, etc.) can be stored. A hook 7Y or 2 are installed inside the third one to help hand and organize various items if needed.

FIG. 8 illustrates the bottom view of the scrap container 7SC (where the trash inside is from the pencil-sharpener 7P) of FIG. 7 detached from the base by pulling up the elastic openers 7O on both of its sides. By pulling 7O up, the hooks used to attach 7SC to the base are released, freeing the whole part of 7SC with 7P from the base for convenient scrap disposal. The removal of 7SC from the base will reveal its bottom slide cover 8LC. By pushing the grids on 8LC outwardly, it can be slid open easily as a vent for scrap disposal. After dumping the scrap, just slide 8SL back to close the opening and attach 7SC to the base again by means of pulling 7O up again and aiming the hooks to the holes of their matches.

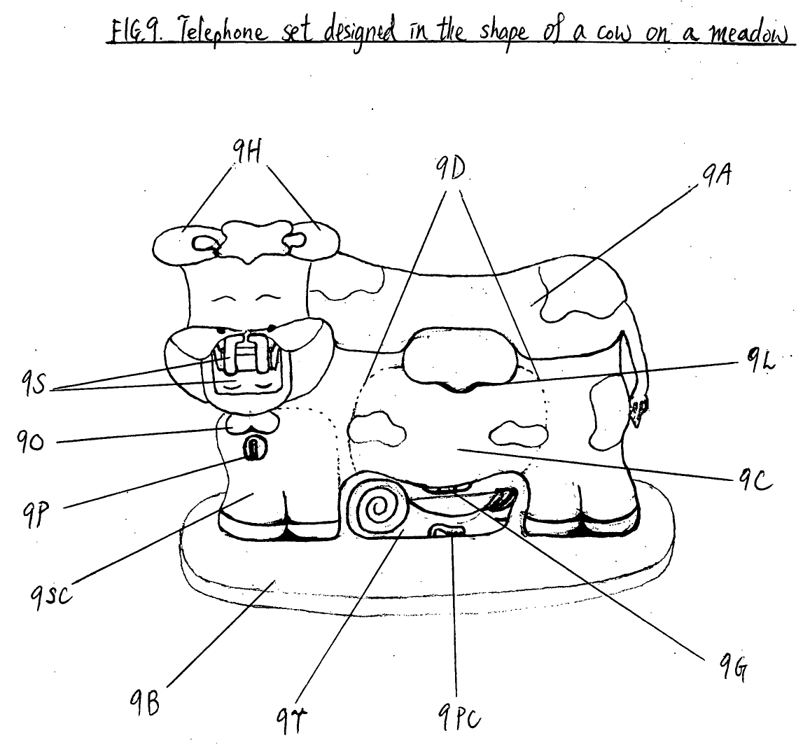

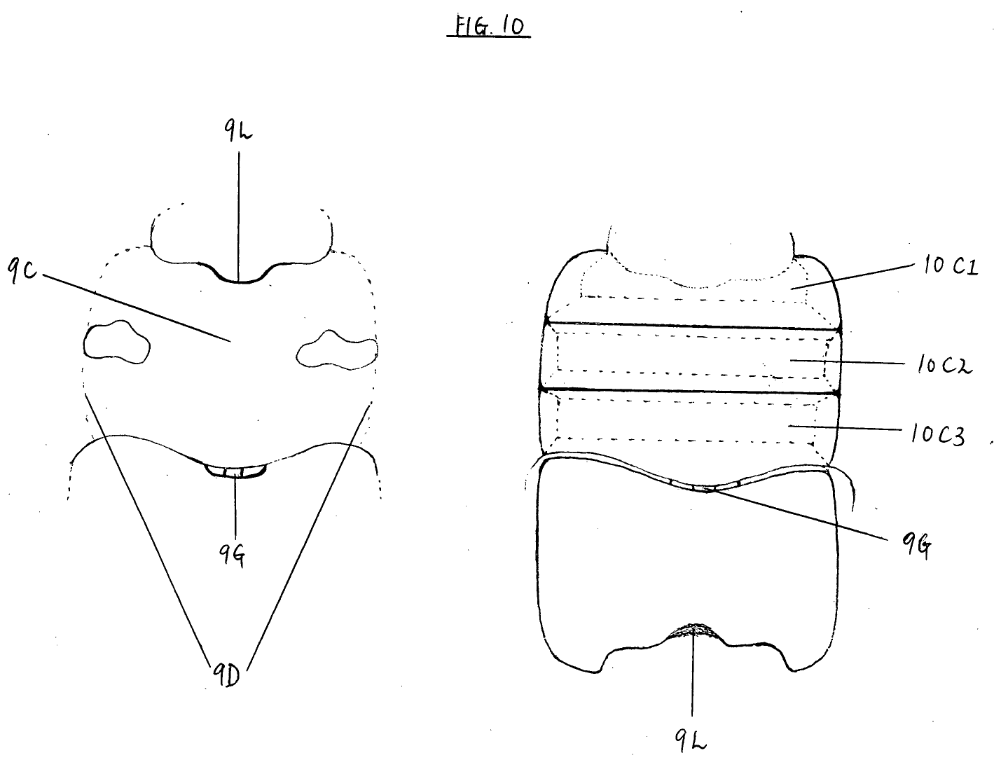

FIG. 9 illustrates a perspective side view of another aesthetic embodiment of a telephone set (designed in the shape of a cow on a meadow) preferably with the use of synthetic fur as its exterior cover. The receiver 9A is placed on the top, being a part of the cow's back. Under 9A, there is a well-covered compartment 9C with 3 subdivisions. A lip lid 9L is used to open the cover of 9C with a hinge 9G at the base to facilitate its movement. 9L is not obvious in appearance because of the presence of (i) a camouflage color of the patch of the cow's body, and (ii) a layer of exterior cover of synthetic fur. The scope of 9C is indicated by two dotted lines 9D, which are only for illustration of the part 9C and will not appear in the real product. More details about 9C and its subdivisions will be shown and described in FIG. 10. 9A and 9C are unified as the body part of the cow. The telephone set can be cordless or corded. In case it is corded, the cow's tail will be the corded part.

Under 9C (the stomach part of the cow), there is a snail-shaped tape dispenser 9T according to the present invention.

A plastic clip 9PC, which is attached to the meadow base 9B at the back of 9T, is used to fasten 9T in place so that it will not slide away whatever position the telephone set is put, even on a vertical surface.

For the head part of the cow, the 2 specifically-designed horns 9H are used as holders for writing implements. 9H are open-ended plastic rings flexible in diameter expansion (about 0.5 cm to 1.5 cm) so that different thicknesses of writing implements can be adapted and held tight. 9H can also be made flexible in rotation so that the wiring implements held along with will not interfere with the use of an embedded stapler 9S under. This also gives users convenience for their preferences in positional adjustments.

Under 9H, there is a stapler 9S embedded in the mouth part of the cow. The way of incorporation is the same as that of 1S in the mouth part of the bear. Please refer to page 5, line 33-36, and page 6, line 10-15 for detailed descriptions of the incorporation.

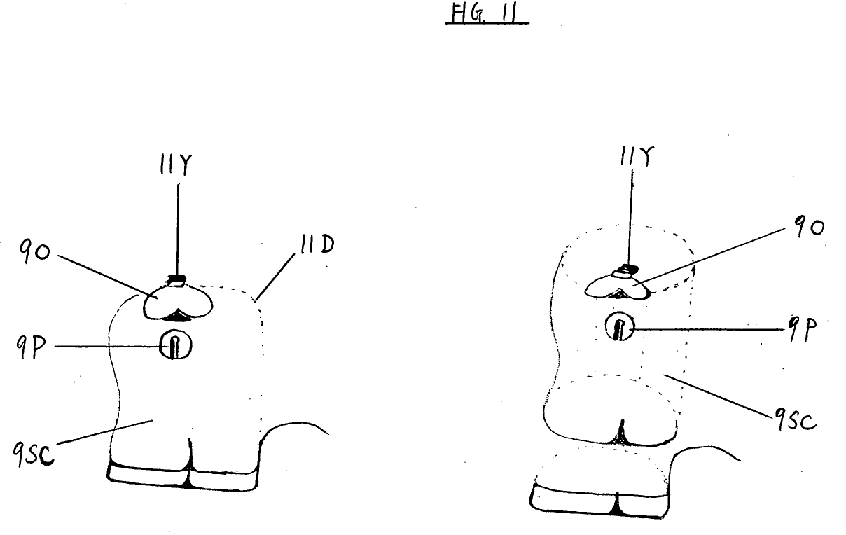

Under 9S, there is a pencil-sharpener 9P with its scrap container 9SC blended in as the front-leg part of the cow according to the present invention. There is a pulled-up opener 9O as the collar part of the cow to remove 9SC from the telephone set for scrap disposal. More details about 9SC will be illustrated and described in FIG. 11.

FIG. 10 illustrates the front view of the compartment 9C only (on the left hand side as the stomach part of the cow in FIG. 9), showing its exposed, inside view when the cover is pulled open by the lip lid 9L (demonstrated on the right hand side in FIG. 10). There are 3 subdivisions 10C1, 10C2 and 10C3 in this case according to the present invention. The 3 subdivisions are not in same sizes because they are derived from the space of the stomach part of the cow, and have to integrate with its outline. They are designed to hold and store, including but not limited to, stationery and office implements (e.g. note pad, correction pen, paper clips, rubber bands, staples, ruler, eraser, etc.).

FIG. 11 illustrates the front view of the pencil sharpener 9P with its scrap container 9SC only (as the front-leg part of the cow in FIG. 9), showing how 9SC can be removed for scrap disposal. A dotted line 11D is only used for indication of the scope of 9P and will not appear in the real product. The collar part of the cow is a pulled-up opener 9O used to remove 9SC from the telephone set for scrap disposal. There is a small indent under 9O to facilitate its holding for the pulling up action. After 9O has been pulled up and the hook 11Y has been released, 9SC can be pulled out from the telephone set for scrap disposal. 9SC is basically cylindrical in shape.

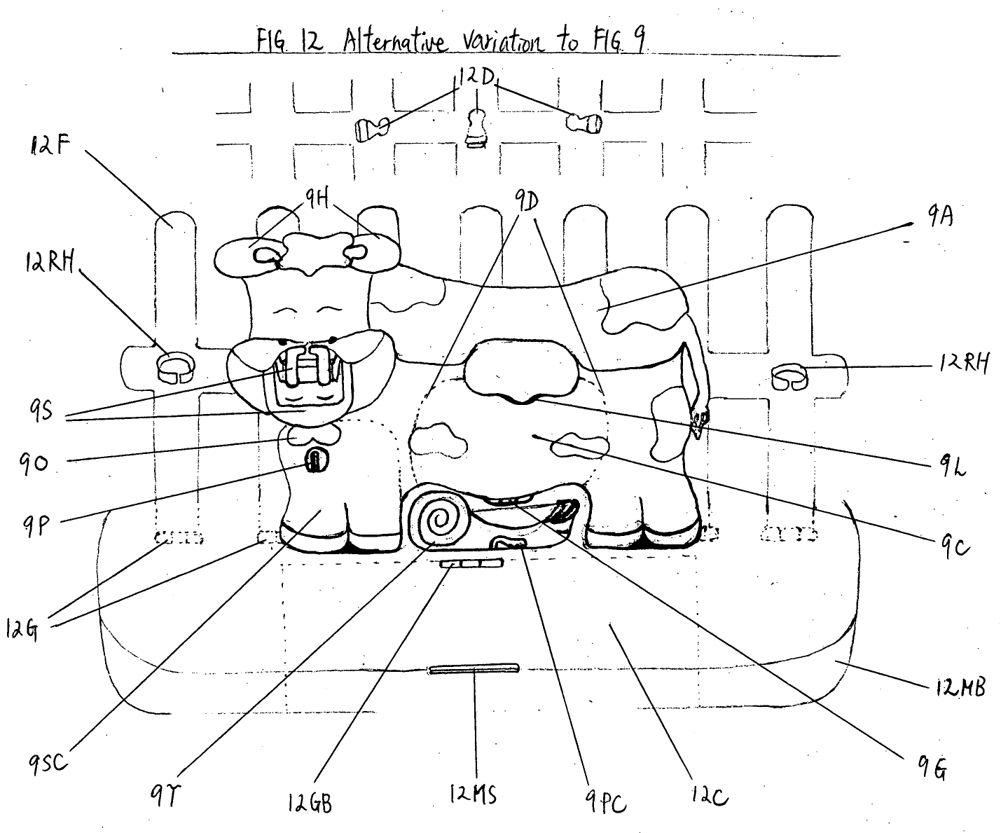

FIG. 12 illustrates a side view of an alternative variation to FIG. 9, indicating one of the possible expansions of the holding and storing capacities to FIG. 9 for the purpose of providing options for manufacturers and potential users.

The expansions include mainly two parts: (I) On a base-movable, fence-shaped design 12F behind the cow-shaped telephone set, there are two plastic-ring holders 12RH for writing implements on the opposite ends with 3 document clips 12D for, including but not limited to, paper materials (e.g. note pad, paper, card, photo, etc.) in the middle. The fence-shaped base is made movable by hinges 12G for convenient position adjustments when the telephone set is placed on different surfaces.

(II) Under the cow-shaped telephone set and the fence-shaped design, the meadow-shaped base 12MB is expanded in size (including length, width and depth) in order to contain another well-covered compartment 12C in addition to 9C. Such an addition provides more space for holding and storing different kinds of stationery and office implements. The cover of 12C is kept closed by 2 magnetic stripes 12MS, which can also be pulled open, with a hinge 12GB at the opposite side to facilitate its movement.

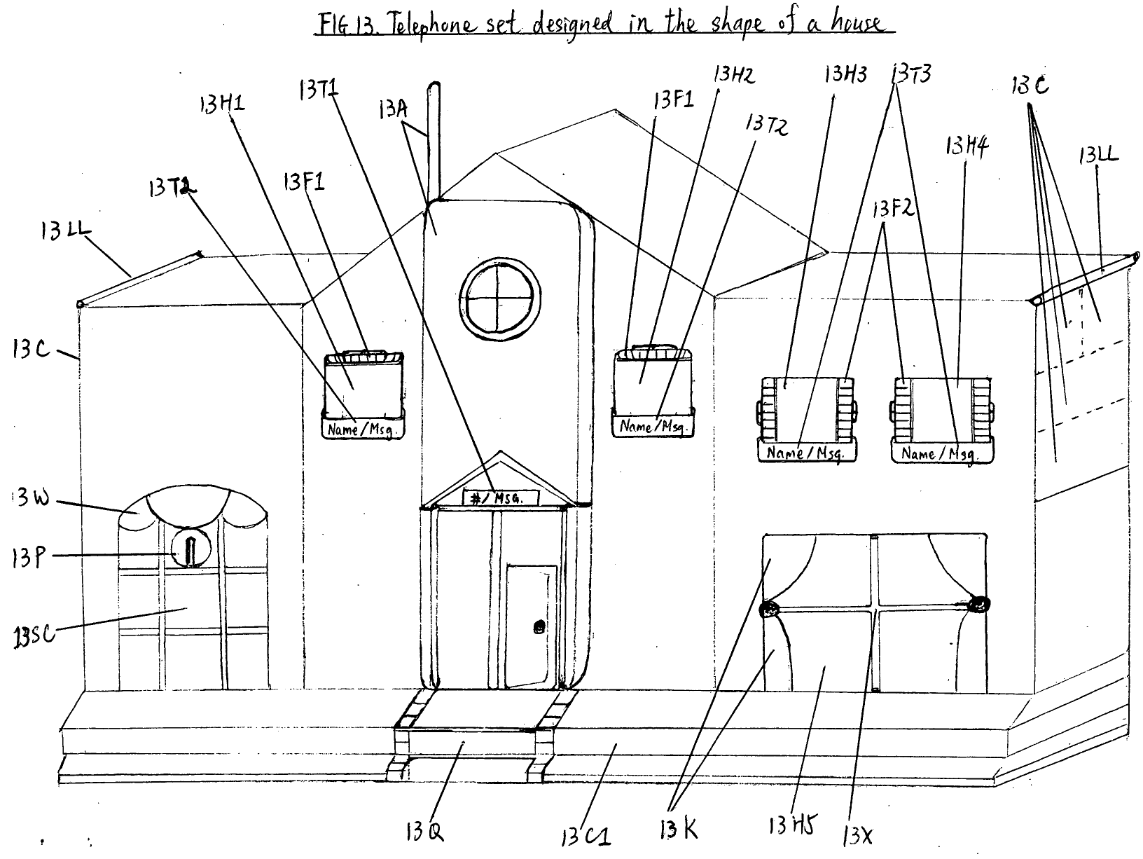

FIG. 13 illustrates a perspective front view of another aesthetic embodiment of a telephone set designed in the shape of a house. The receiver 13A with an antenna in the diagram is designed as the front door of the hose with a chimney. Decorative paintings of window and pillars are also on 13A. Above the painted door (around the middle of 13A), there is a tag 13T1 protected by a thin plastic layer, which can be removed from the receiver. 13T1 is left blank originally so that it can be inscribed with numbers, characters, or alphabets of simple words to personalize individual user's or family needs.

For example, 13T1 can be inscribed with the actual apartment or house number a person or family lives, the person's or family name who has bought the telephone set, the special date (e.g. date of buying or moving into a house, marriage date, etc) or characters a person or family celebrates or remembers, etc.

On both sides of 13A, there are two symmetrical, window-shaped picture holders 13H1 and 13H2 with a tag 13T2 under each of them. A picture is held in place by a shutter-shaped or roman-shade, preferably but not exclusively, wooden clip fastener 13F1 at the top. 13T2 is covered by a plastic or glass layer, or is contained within 2. As 13T1, 13T2 can be removed for number, character, or words inscription.

Under 13A, there is a step-like recessed handle 13Q used to pull open the drawer-like compartment 13C1, which can store small objects and thin materials, including but not limited to, cards, envelopes, note pads and pieces of paper. 13C1 can be designed to contain subdivisions. There can also be more drawer-like compartments designed under 13A.

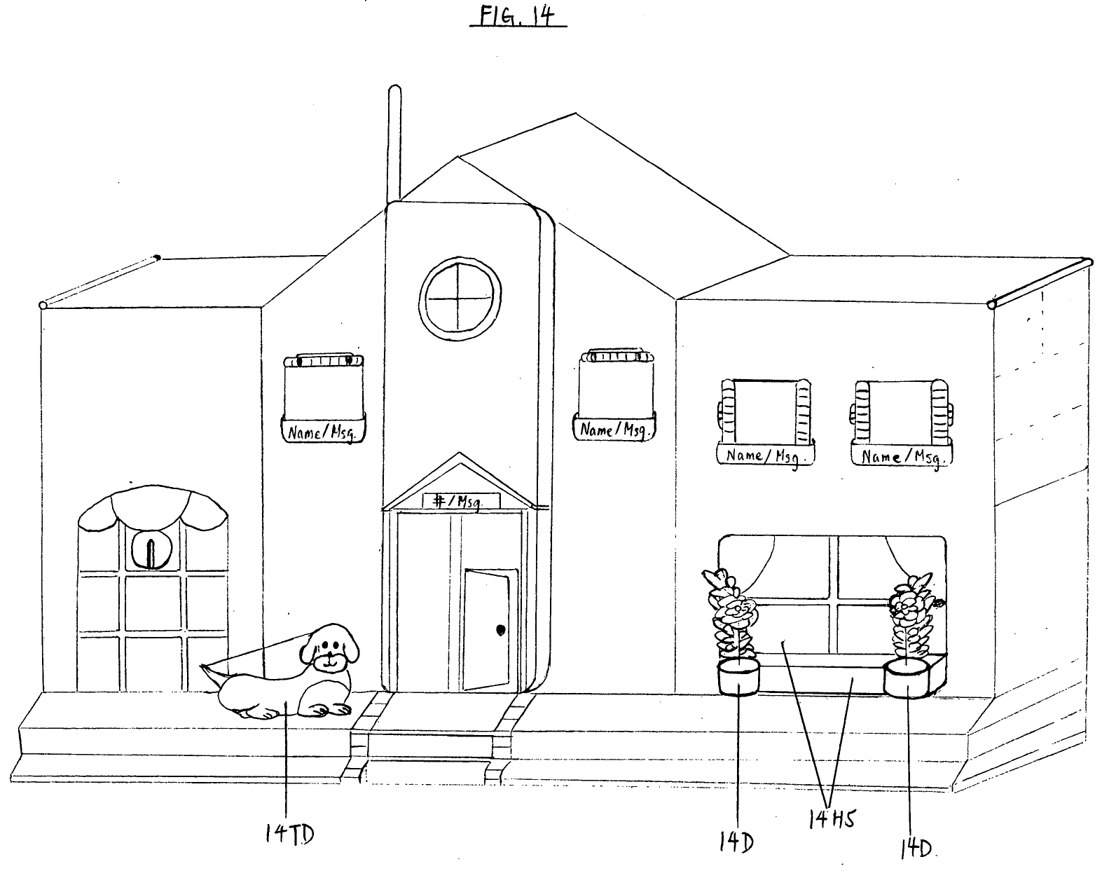

On the right hand side of the figure, there are two more window-shaped picture holders 13H3 and 13H4 with a tag 13T3 under each of them, too. A picture is held in place by 2 shutter-shaped fasteners 13F2 on the sides, which are alternative designs of 13F1. Under 13H3 and 13H4, there is a bigger picture holder 13H5. The cross at the center 13X is used as a divider to divide 13H5 into subdivisions. However, 13X can be removed to allow one big picture to occupy the whole 13H5. Pictures are held in place by the curtain-shaped clips, corner pinch or pocket 13K as well as the cross. 13H5 can be modified to be used as a business card holder as shown in FIG. 14.

On the left hand side of the figure, there is a window-shaped pencil sharpener 13P with a scrap container 13SC, which can be removed for scrap disposal by pulling the scallop-shaped curtain handle 13W up so that the hook above can be released, The operation of 13W for scrap disposal is similar to that of 9O explained in FIG. 11. Please refer to page 8, line 32-35 for detailed descriptions.

On each side of the house there is a well-covered compartment 13C respectively with subdivisions to hold, store and organize stationery (e.g. stapler & staples, rubber bands, paper clips, etc.) as well as writing implements (e.g. pens, pencils, markers, etc.). The cover can be slid open and closed by a lip lid 13LL, which is designed as the shape of a gutter.

FIG. 14 illustrates the front view of an alternative variation to FIG. 13, indicating one of the possible modifications of the use of one of the picture holders—that is, changing it into a business card holder. All parts in FIG. 14 remain the same as those in FIG. 13 except the part for 13H5, which is modified into a business card holder 14H5. 14H5 can be designed with different shapes, colors, patterns & decorations, including but not limited to, the (colorful) flower plants with irregular edges as shown in FIG. 14. It can also be designed with different materials, including but not limited to, wood, glass, plastics or ceramics, as long as it is compatible and looks consistent with other parts of the telephone set.

In FIG. 14, 14H5, including the part of the flower plant decorations 14D is supposed to be made of plastics either transparent or color-tinted which is harmonized with other parts of the telephone set. 14D is most desirable to be colored with different hues. 14D, as well 14H5, can also be designed with stain-glass effect decor when the use of materials changes as stated in the aforesaid.

In FIG. 14, a dog-shaped tape dispenser 14TD is added. It is not made integrated but harmonized with the design of the telephone set. 14TD can be removed without affecting the integrity and the general appearance of the telephone set.

Therefore, 14TD can also be present in FIG. 13.

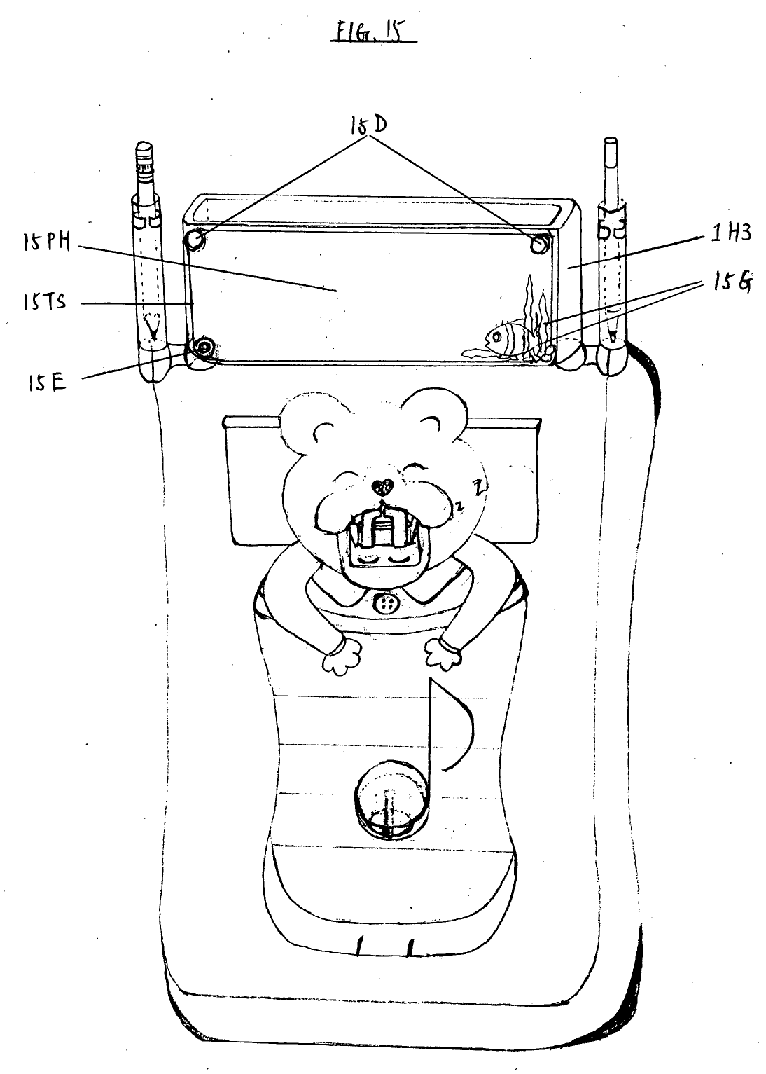

FIG. 15 illustrates the front view of an alternative variation to FIG. 1—Telephone set designed in the shape of a sleeping bear on a bed, indicating one of the possible changes on the design of the picture holder, which is in front of the rectangular (stationery) holder 1H3. All features in FIG. 15 remain the same as those in FIG. 1; the only difference is on the design of the picture holder 15PH in front of 1H3.

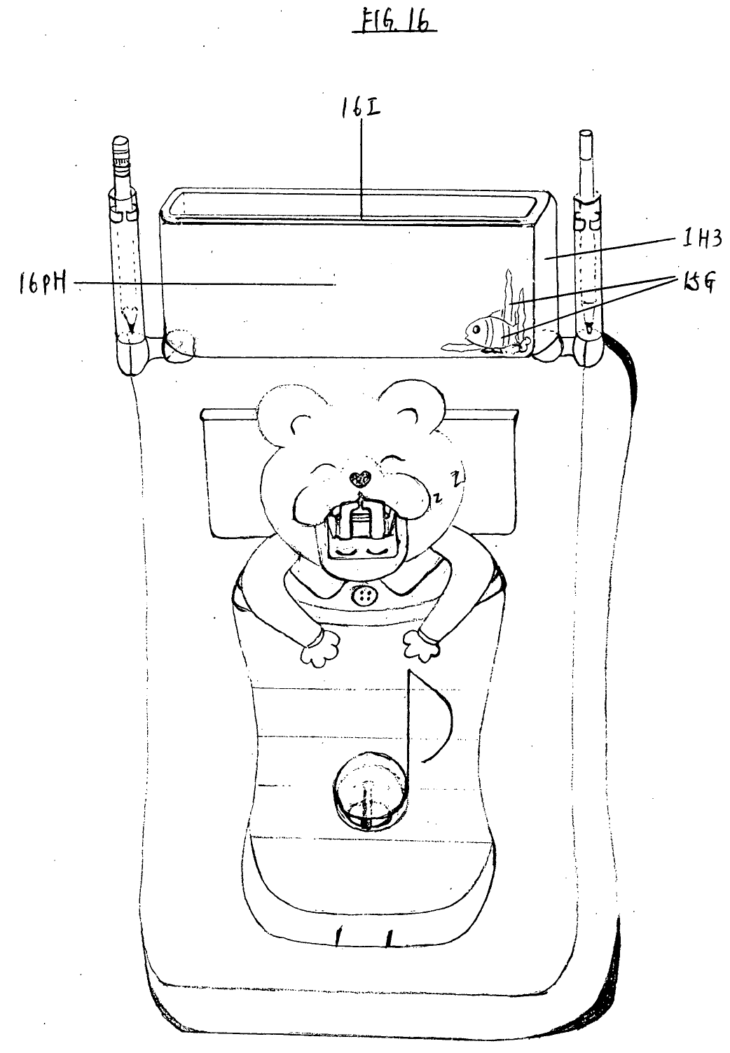

In FIG. 1, the picture holder is designed to be made of 4 decorative plastic latches 1L in bear-foot patterns (which, in fact, can also be made of any other shape, color, material) and preferably but not necessarily covered by a transparent or color-tinted slide 1TS to protect the picture. In FIG. 15, however, the picture holder 15PH is designed to be made of stain-glass effect decor 15G with, including but not limited to, fish and coral patterns. There is a slide 15TS, which can either be transparent or color-tinted, attached with or put separately under the stain-glass designed patterns, which is supported or joined by pads 15D and/or clip rings or eyehooks 15E so that a picture or the like can be inserted under 15TS. If possible, there can be a built-in slit within the front part of 1H3 so that the stain-glass effect decor can be made directly on it without using 15TS and the supporting parts 15D or joints 15E. Please see FIG. 16 for reference.

FIG. 16 illustrates the front view of a possible variation to FIG. 15, showing a built-in slit picture holder 16PH with stain-glass effect decor 15G of, including but not limited to, fish and coral patterns. The main difference between FIG. 15 and FIG. 16 is on the inserting part of the picture (or the like) as well as the supporting parts associated with it.

In FIG. 15, the picture holder 15PH is composed of a transparent or color-tinted slide 15TS with supporting pads 15D or/and joints 15E attached in front of the rectangular (stationery) holder 1H3 so that a picture (or the like) can be inserted into the slight slit opening between the front part of 1H3 and the slide 15TS.

In FIG. 16, however, the picture holder 16PH is created by having a built-in slit 161 made at the front part of 1H3 so that a picture (or the like) is inserted into the slight slit opening formed within the front side of 1H3. This means 16PH is embedded in the front edge of 1H3 while 15PH is topped on the front side of 1H3. As 16PH is a built-in unit at the front edge of 1H3, no supporting parts 15D or joints 15E used to construct 15PH are needed. As a result, the stain-glass effect decor 15G, the fish and coral patterns in this case, can be made directly on the front side of 1H3 for 16PH while 15G has to be made on a separate layer in front 15TS for 15PH.

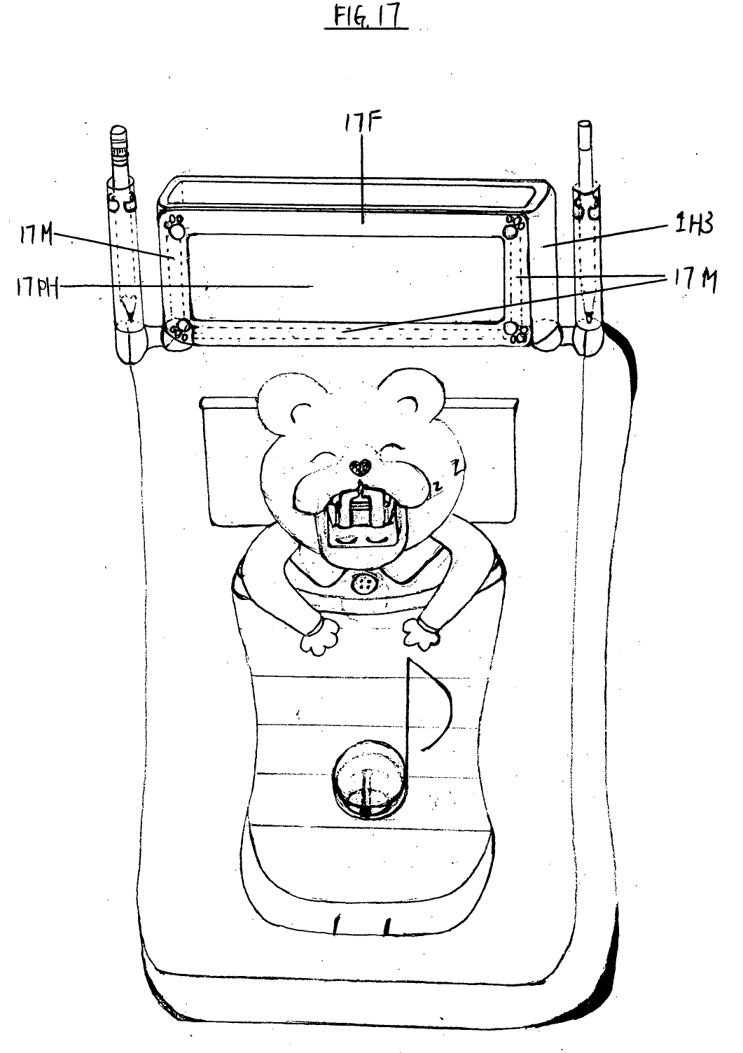

FIG. 17 illustrates the front view of another possible variation to FIG. 1 as on the design of the picture holder, indicating a rectangular frame 17F (with pads or supporting materials underneath which are shown as dotted lines 17M in the figure) and, including but not limited to, bear-foot prints as decorative design on it.

The frame 17F with pads (or supporting material) 17M can be designed into different shapes, colors and textures, and can have one or more patterns on it while the picture holder itself can be made to have subdivisions to hold more than one picture or the like.

17M in FIG. 17 have 2 main functions: First, they create an opening between 17F and 1H3 to enable a picture or the like to be inserted, which constitute a picture holder 17PH; second, they provide support for the picture to stay in and not to slip out from the bottom. Although the former patented invention, a wall telephone stand, by Genaro et al, does include a frame as one of the features in their invention, it neither includes any pad (or supporting material) for the frame nor states it can be used as a picture holder or the like. It just mentioned the frame in their invention was for decoration of the chalkboard or the like in their invention. In regard of this, the frame with pads or the like is actually an obvious and important modification to theirs, and should be regarded as one of the features in my invention.

17M can be shaped in, including but not limited to, stripes (as shown in FIG. 17) or small circles, which are situated behind the 3 edges of 17F, forming a U-shaped pattern which creates an opening between 17F and 1H3 for a picture (or the like) to be inserted, and provides support for the picture to stay within 17F.

While the invention has been described with respect to a limited number of embodiments, it will be appreciated that many variations, modifications and other applications of the invention may be made. For example, the cylindrical holders 1H1 & 1H2 can be expanded in size (i.e. wider in diameter) and made without the plastic rings 1R, or made in other shapes with curvature or/and ornaments.

1. A telephone set designed in the shape of, including but not limited to, an animal, device, furniture, figurine, utensil, house, automobile, or any combination of the aforesaid and by making use of the featured design of the shape, comprising any combination of the following:
(a) a stapler integrated with the design;
(b) a pencil sharpener integrated with the design;
(c) a tape dispenser harmonized with the design;
(d) at least one built-in, covered compartment preferably with subdivisions;
(e) at least one, 3-sided open holder with an elastic, including but not exclusively, metal clip attached at its base to hold, including but not limited to, paper materials and stationery in place;
(f) at least one, 1-sided open, position-adjustable stationery holder, preferably but not necessarily, with at least one picture holder;
(g) at least one picture holder, preferably but not necessarily, with a tag which can be inscribed with words to personalize the picture or the like;
(h) at least two position-adjustable, open-ended, elastic, ring-shaped writing-implement holders to secure the writing implements in place;
(i) at least two, including but not limited to, cylindrically-shaped writing-implement holders with an elastic, preferably open-ended, ring clip attached inside respectively to secure the writing-implements in place;
(j) a business card holder

2. The stapler as in claim 1(a), wherein: it is integrated as, including but not limited to, the mouth part of an animal in the design of a telephone set;

3. The stapler as in claim 1(a), wherein: it can also be integrated with any part in any other shape of a design of a telephone set, no matter whether the design is an animal, utensil, device, house, furniture, figurine, or any combination of the aforesaid, or other objects of design of a telephone set;

4. The pencil sharpener as in claim 1(b), wherein: it, preferably but not necessarily, comes with a scrap container integrated with the design in which the said container can be detached from the telephone set for scrap disposal purpose;

5. The pencil sharpener as in claim 1(b), wherein: it can be detached from the telephone set for pencil sharpening and scrap disposal purposes if a scrap container is not included in the design;

6. The tape dispenser as in claim 1(c), wherein: it is designed in the shape of, including but not limited to, a snail or a dog;

7. The built-in, covered compartment as in claim 1(d), the shape, color, texture and the way of opening of said compartment including its cover have indefinite possibilities, depending on the design of the telephone set;

8. The built-in, covered compartment as in claim 1(d), wherein: the sizes of individual subdivisions of said compartment can be the same, but also can be different within each compartment;
9. The built-in, covered compartment as in claim 1(d), wherein: any of the subdivisions of the said compartment may have one or more built-in hooks;

10. The 1-sided open, position-adjustable stationery holder as in claim 1(f), wherein: including but not limited to the base of the holder is made position-adjustable, which can be pivoted at least 180° to the base of the telephone set;

11. The picture holder as in claim 1(g), composed of any of the following:
(a) decorative latches (in the front), including but not limited to, bear foot-print patterns, to hold the picture or the like in place, preferably but not necessarily, with a slide either transparent or color-tinted, to cover and protect it;
(b) Stain-glass effect decor with a built-in slit or an attached slide either transparent or color-tinted;
(c) Shutter-shaped or roman-shade like clip(s) or fastener(s) to hold a picture or the like in place, preferably but not necessarily, with a slide either transparent or color-tinted to cover and protect it;
(d) A frame with pads or supporting materials made with either, including but not limited to, foam, plastics, or glass, and preferably with an attached slide either transparent or color-tinted to hold a picture or the like;

12. The said picture holder as in claim 11(a), (b), (c) or (d), wherein: the said latches, stain-glass effect decor, the shutter-shaped or roman-shade fasteners, or the frame with pads can be designed into different shapes, colors and textures, and can have one or more patterns on while the picture holder itself can be made to have subdivisions to hold more than one picture or the like;

13. The picture holder as in claim 1(g), wherein: the said tag is covered by either, including but not limited to, a plastic or glass layer, or is contained in the aforesaid-made tag/stripe holder from which the tag or stripe can be removed.

14. The two position-adjustable, open-ended, elastic, ring-shaped holders as in claim 1(h), wherein: the said ring-shaped holders are flexible in diameter expansion (from about 0.5 cm to 1.5 cm), and can be designed into different patterns, colors and textures;

15. The writing-implement holders as in claim 1(i), wherein: They are, preferably but not necessarily, position-adjustable; in case the interior, elastic ring clip is not used in the design, or the writing-implement holders are expanded in size to be able to hold more than 1 unit in each one of them, they have to be position-adjustable;

16. The business card holder as in claim 1(j), wherein: it can be designed with different shapes, colors, patterns (including but not limited to, flower plants) and materials (including but not limited to, wood, glass, plastics or ceramics);

17. The keypads on a telephone set can be designed in the shape of, including but not limited to, lips, stars, balls, hearts, animals, devices, furniture, figurines, utensils, automobiles, or houses.
